(19) United States
(12) Patent Application Publication
(10) Pub. No.: US 2025/0225017 A1
(43) Pub. Date: Jul. 10, 2025

(54) DEVICES, SYSTEMS, AND METHODS FOR OUT-OF-BAND DELIVERY OF ERROR REPORTS

(71) Applicants: ATI Technologies ULC, Markham (CA); Advanced Micro Devices, Inc., Santa Clara, CA (US)

(72) Inventors: Vilas Sridharan, Boxborough, MA (US); Vamsi Krishna Alla, Austin, TX (US); Maher Mounir Moghabghab, Markham (CA); Kabita Rani Saha, Austin, TX (US); Carlos Vallin, Austin, TX (US); Vignesh Vaidhyanathan Seshan, Markham (CA)

(73) Assignees: ATI Technologies ULC, Markham (CA); Advanced Micro Devices, Inc., Santa Clara, CA (US)

(21) Appl. No.: 19/096,506

(22) Filed: Mar. 31, 2025

Related U.S. Application Data
(63) Continuation-in-part of application No. 18/089,128, filed on Dec. 27, 2022.

(51) Int. Cl. G06F 11/07; G06F 11/34

(52) U.S. Cl. CPC G06F 11/0784; G06F 11/3476

(57) ABSTRACT

A system comprises a machine check architecture and a processor. The machine check architecture is configured to log hardware errors. The processor is configured to obtain a log of one or more of the hardware errors from the machine check architecture and/or to generate a copy of the log. The processor is further configured to either (1) deliver the log to an in-band agent and the copy of the log to an out-of-band agent or (2) deliver the copy of the log to the in-band agent and the log to the out-of-band agent. Various other devices, systems, and methods are also disclosed.

### CROSS REFERENCE TO RELATED APPLICATION

This application is a continuation-in-part of U.S. application Ser. No. 18/089,128 filed Dec. 27, 2022, the disclosure of which is incorporated in its entirety by this reference.

### BACKGROUND

Machine check architectures are often used to report errors to an in-band driver and then to a system console or kernel log. Unfortunately, some machine check architectures are unable to report those errors to certain out-of-band agents like the control planes of data centers, which could benefit from such error reporting. The instant disclosure, therefore, identifies and addresses a need for additional and improved devices, systems, and methods for out-of-band delivery of error reports generated by machine check architectures.

### BRIEF DESCRIPTION OF THE DRAWINGS

The accompanying drawings illustrate a number of exemplary implementations and are a part of the specification. Together with the following description, these drawings demonstrate and explain various principles of the instant disclosure.

FIG. 1 is a block diagram of a portion of an exemplary computing device that facilitates out-of-band delivery of error reports according to one or more implementations of this disclosure.

FIG. 2 is a block diagram of an exemplary graphics processing unit (GPU) that facilitates out-of-band delivery of error reports according to one or more implementations of this disclosure.

FIG. 3 is a block diagram of an exemplary computing device that facilitates out-of-band delivery of error reports according to one or more implementations of this disclosure.

FIG. 4 is a block diagram of an exemplary implementation involving a computing system that facilitates out-of-band delivery of error reports to a data center according to one or more variations of this disclosure.

FIG. 5 is a block diagram of a portion of an exemplary GPU that implements banks of a machine check architecture according to one or more implementations of this disclosure.

FIG. 6 is a flowchart of an exemplary method for out-of-band delivery of error reports according to one or more implementations of this disclosure.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the instant disclosure covers all modifications, equivalents, and alternatives falling within the scope of the appended claims.

### DETAILED DESCRIPTION OF EXEMPLARY IMPLEMENTATIONS

The present disclosure describes various devices, systems, and methods for out-of-band delivery of error reports. In some examples, delivery of error reports to an out-of-band agent (e.g., a baseboard management controller, a system management controller, a data center control plane, etc.) can impair and/or degrade the performance of processors that forward the error reports. In addition to forwarding the error reports to the out-of-band agents, such processors can elevate the reporting privileges above those of typical user applications, thus pushing the processors to operate in system management mode. Unfortunately, system management mode creates security vulnerabilities that can enable malware to gain control of the processors.

Moreover, machine check architectures can involve shadow registers that are accessible to both an in-band agent (e.g., an in-band driver, a system console, a kernel log, a user and/or data plane, etc.) and an out-of-band agent for changing the state of the error reports. Unfortunately, race conditions that potentially lead to undesirable results and/or sequencing may arise from both the in-band agent and the out-of-band agent having access to these shadow registers. For example, the in-band agent may clear one or more of its registers, thus causing a shadow register included in the machine check architecture to be cleared. In this example, because the shadow register is cleared by the in-band agent, the out-of-band agent may be unable to access, obtain, and/or analyze the error report. As will be described in greater detail below, the devices, systems, and methods described herein can enhance and/or augment machine check architectures so that reporting entities (e.g., graphics processing units, memory controllers, central processing units, etc.) are able to send error reports to the in-band agent and the out-of-band agent simultaneously.

As a specific example, an enhanced block and/or circuit of a machine check architecture can constitute and/or represent a pipeline that includes two independent and/or parallel lanes for reporting errors to the in-band agent and the out-of-band agent simultaneously. By doing so, the enhanced block and/or circuit of the machine check architecture facilitates error reporting to both the in-band agent and the out-of-band agent without the need for the in-band agent to expend in-band workload potential for out-of-band error reporting, thereby improving the performance of the user applications running on the underlying device and/or in-band agent. In addition, the enhanced block and/or circuit of the machine check architecture facilitates error reporting to both the in-band agent and the out-of-band agent without elevating the underlying device and/or in-band agent to system management mode or creating race conditions between the in-band agent and the out-of-band agent, thereby improving the security of the underlying device and/or in-band agent and mitigating disjointed or mismatched states between the in-band agent and the out-of-band agent due to race conditions.

In some examples, a traditional graphics processing unit (GPU) reports errors to an in-band driver and then to a system console or kernel log. Unfortunately, this traditional GPU is unable to report those errors directly to a certain out-of-band agent like the control plane of a data center, which could benefit from such direct error reporting.

To address this deficiency, a new GPU can include and/or represent a machine check architecture and/or an onboard microcontroller or system management unit. In some examples, the machine check architecture can detect and/or record a hardware error that occurs on the GPU. In one example, the onboard microcontroller or system management unit implements firmware that obtains a report describing the hardware error from the machine check architecture. In this example, the firmware generates a copy of the report to facilitate delivering the report or the copy to both an in-band agent (e.g., an in-band driver, a system console, a kernel log, a user and/or data plane, etc.) and an out-of-band agent (e.g., a baseboard management controller, a system management controller, a data center control plane, etc.).

In some examples, a system comprises a machine check architecture and a processor. In such examples, the machine check architecture is configured to log hardware errors. In one example, the processor is configured to obtain a log of one or more of the hardware errors from the machine check architecture and/or to generate a copy of the log. In this example, the processor is further configured to either (1) deliver the log to an in-band agent and the copy of the log to an out-of-band agent or (2) deliver the copy of the log to the in-band agent and the log to the out-of-band agent. In certain implementations, the system comprises a GPU or a peripheral component interconnect express (PCIe) device that incorporates and/or implements the machine check architecture and/or the processor.

In some examples, the processor is further configured to execute firmware that obtains the log and generates the copy of the log. In one example, the firmware is configured to allocate a first buffer for storing the log or the copy of the log destined for the in-band agent. In this example, the firmware is further configured to allocate a second buffer for storing the log or the copy of the log destined for the out-of-band agent.

In some examples, the processor is configured to deliver the log or the copy of the log to the in-band agent via the first buffer. In such examples, the processor is configured to deliver the log or the copy of the log to the out-of-band agent via the second buffer.

In some examples, the firmware is configured to poll the machine check architecture on a periodic basis and obtain the log upon polling the machine check architecture. In such examples, the firmware is configured to clear, after obtaining the log, a feature of the machine check architecture to indicate that the log has been reported. In one example, the machine check architecture is configured to trigger an interrupt when a hardware error occurs. In this example, the firmware is configured to obtain the log in response to the interrupt having been triggered.

In some examples, the in-band agent comprises a driver, a system console, a kernel log, or a data plane of a data center. Additionally or alternatively, the out-of-band agent comprises a baseboard management controller, a system management unit, or a control plane of a data center.

In one example, the system further comprises a pipeline with a first lane that carries the log or the copy of the log toward the in-band agent and/or a second lane that carries the log or the copy of the log toward the out-of-band agent. In this example, the in-band agent and the out-of-band agent are configured to make error-logging decisions independent of one another. Additionally or alternatively, the out-of-band agent is configured to instruct the machine check architecture to perform a specific action in response to a specific error identified in the log.

In some examples, a GPU comprises a machine check architecture and a microcontroller. In such examples, the machine check architecture is configured to log hardware errors. In one example, the microcontroller is configured to obtain a log of one or more of the hardware errors from the machine check architecture and/or to generate a copy of the log. In this example, the microcontroller is further configured to either (1) deliver the log to an in-band agent and the copy of the log to an out-of-band agent or (2) deliver the copy of the log to the in-band agent and the log to the out-of-band agent.

In some examples, a method comprises creating a machine check architecture that logs hardware errors. In one example, the method also comprises configuring a processor to obtain a log of one or more of the hardware errors from the machine check architecture and to generate a copy of the log. In this example, the method further comprises configuring the processor to either (1) deliver the log to an in-band agent and the copy of the log to an out-of-band agent or (2) deliver the copy of the log to the in-band agent and the log to the out-of-band agent.

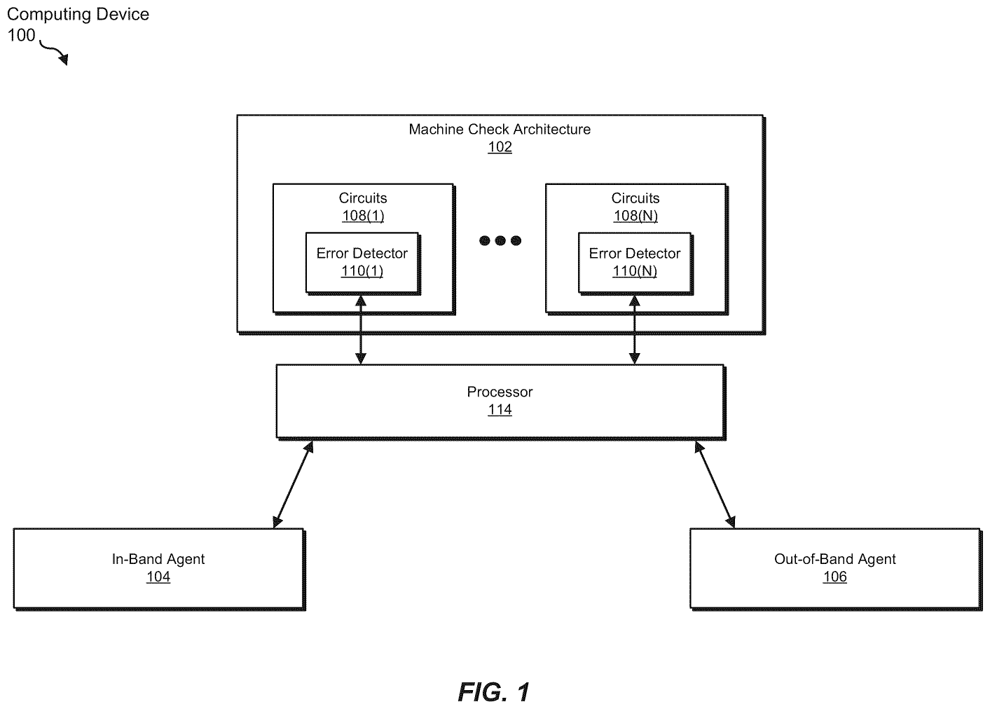

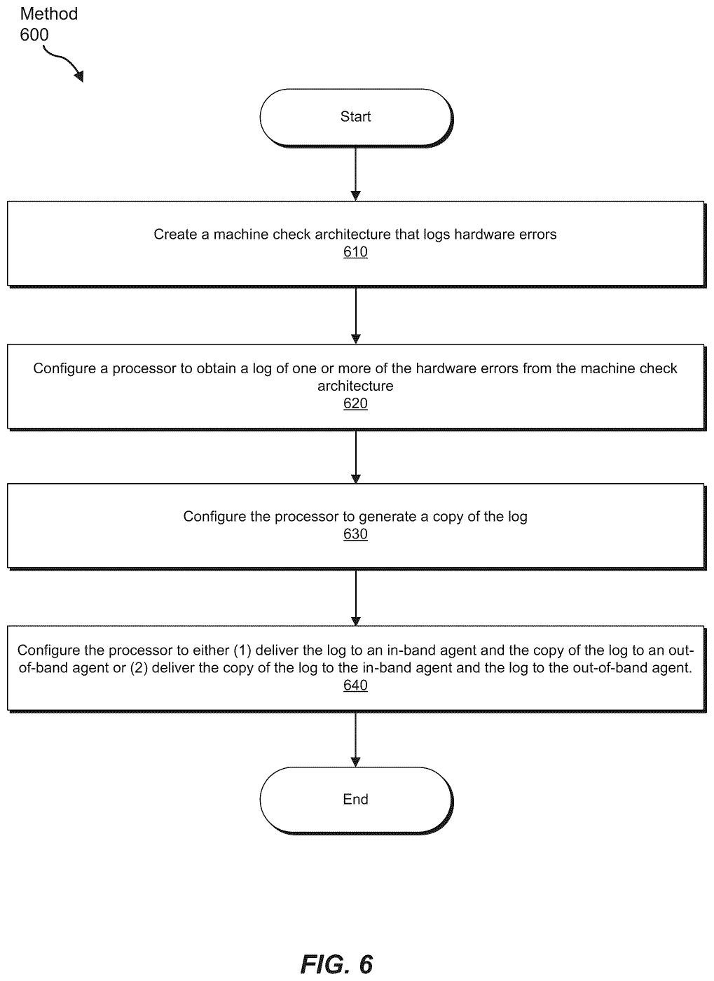

The following will provide, with reference to FIGS. 1-5, detailed descriptions of exemplary devices, systems, and/or corresponding implementations for out-of-band delivery of error reports. Detailed descriptions of an exemplary method for out-of-band delivery of error reports will be provided in connection with FIG. 6.

FIG. 1 illustrates an exemplary computing device 100 that facilitates and/or supports out-of-band delivery of error reports. As illustrated in FIG. 1, exemplary computing device 100 includes and/or represents a machine check architecture 102, a processor 114, an in-band agent 104, and/or an out-of-band agent 106. In some examples, computing device 100 includes and/or represents a GPU or a peripheral component interconnect express (PCIe) device that incorporates and/or implements the machine check architecture and/or the processor.

In some examples, machine check architecture 102 includes and/or represents a plurality of circuits 108(1)-(N). In one example, circuits 108(1)-(N) include and/or represent error detectors 110(1)-(N), respectively. In this example, error detectors 110(1)-(N) sense and/or detect errors that occur in circuits 108(1)-(N), respectively, and/or report the errors to processor 114.

In some examples, processor 114 is electrically and/or communicatively coupled to machine check architecture 102. For example, processor 114 can be electrically and/or communicatively coupled to circuits 108(1)-(N) and/or error detectors 110(1)-(N) in machine check architecture 102. Additionally or alternatively, processor 114 is electrically and/or communicatively coupled to in-band agent 104 and/or out-of-band agent 106 (e.g., via a multilane pipeline).

In some examples, processor 114 obtains, retrieves, and/or receives a log of one or more hardware errors from machine check architecture 102. For example, processor 114 polls machine check architecture 102 for any hardware errors on a period basis. In this example, processor 114 obtains a log of recent hardware errors from machine check architecture 102 upon polling machine check architecture 102. In another example, machine check architecture 102 triggers, throws, and/or trips an interrupt when one or more hardware errors occur. In this example, processor 114 obtains a log of such hardware errors from machine check architecture 102 in response to the interrupt.

In some examples, processor 114 generates, creates, and/or produces a copy and/or duplicate of the log of hardware errors. For example, processor 114 implements and/or executes firmware that generates a second instance and/or copy of the log of hardware errors. In this example, processor 114 delivers, transmits, and/or sends either the log or the copy of the log to each of in-band agent 104 and out-of-band agent 106. As a specific example, processor 114 delivers, transmits, and/or sends the log to in-band agent 104 and the copy of the log to out-of-band agent 106. Alternatively, processor 114 delivers, transmits, and/or sends the log to out-of-band agent 106 and the copy of the log to in-band agent 104.

In some examples, machine check architecture 102 can include and/or represent a circuit, device, and/or mechanism that detects and/or reports errors to another circuit, device, and/or mechanism. For example, a GPU can include and/or implement machine check architecture 102 as well as various processors, memory devices, and/or microcontrollers. In this example, machine check architecture 102 is configured and/or programmed to monitor hardware errors that occur in circuits 108(1)-(N), the processors, the memory devices, the microcontrollers implemented on the GPU, and/or other features or components of the GPU.

In some examples, circuits 108(1)-(N) include and/or represent hardware blocks and/or banks of machine check architecture 102. In one example, the hardware blocks and/or banks include and/or represent memory controllers and/or GPU cores. Additionally or alternatively, the hardware blocks and/or banks include and/or represent control registers and/or model-specific registers used to check for, detect, and/or record various hardware and/or machine errors. Examples of such errors include, without limitation, memory or cache errors, buffer errors, translation errors, parity errors, system bus errors, error-correcting code (ECC) faults, error detection and correction (EDAC) faults, communication errors, input/output (I/O) errors, portions of one or more of the same, combinations or variations of one or more of the same, and/or any other detectable errors.

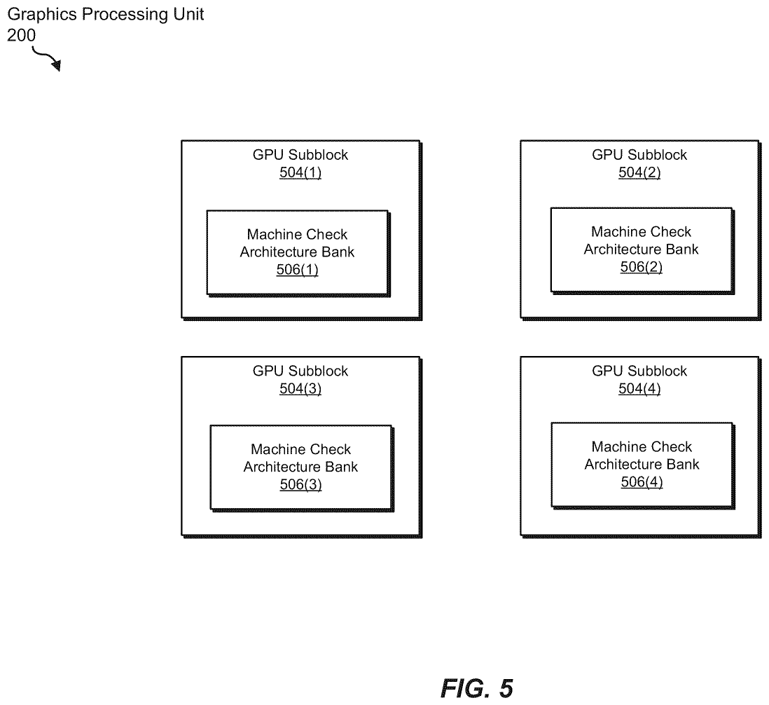

In some examples, machine check architecture 102 can be instantiated and/or implemented as multiple banks across subblocks of one or more GPUs, processors, memory devices, and/or microcontrollers. For example, as illustrated in FIG. 5, a GPU 200 can include and/or represent at least GPU subblocks 504(1), 504(2), 504(3), and/or 504(4). In one example, GPU subblocks 504(1)-(4) can include and/or implement machine check architecture banks 506(1), 506(2), 506(3), and/or 506(4), respectively. Accordingly, machine check architecture 102 can be distributed across GPU subblocks 704(1)-(4), and/or machine check architecture banks 506(1)-(4) can log a specific group of errors per GPU subblock. In certain implementations, each GPU can include and/or represent between 3 and 10 machine check architecture instantiations distributed across corresponding GPU subblocks. In one example, machine check architecture 102 includes and/or represents an accelerator check architecture of GPU 200.

In some examples, processor 114 can include and/or represent a hardware-implemented device and/or circuit capable of executing firmware, an operating system, and/or user applications on computing device 100. For example, processor 114 can include and/or represent a microcontroller onboard a GPU and/or a GPU core. In one example, processor 114 can include and/or represent one of several microcontrollers implemented and/or disposed on the GPU or GPU core. Additionally or alternatively, processor 114 can include and/or represent a system management unit implemented onboard and/or internal to the GPU or GPU core. Additional examples of processor 114 include, without limitation, parallel accelerated processors, tensor cores, microprocessors, field-programmable gate arrays (FPGAs), application-specific integrated circuits (ASICs), central processing units (CPUs), integrated circuits, chiplets, portions of one or more of the same, variations or combinations of one or more of the same, and/or any other suitable processor.

In some examples, processor 114 can implement and/or be configured with any of a variety of different architectures and/or microarchitectures. For example, processor 114 can implement and/or be configured as a reduced instruction set computer (RISC) architecture. In another example, processor 114 can implement and/or be configured as a complex instruction set computer (CISC) architecture. Additional examples of such architectures and/or microarchitectures include, without limitation, 16-bit computer architectures, 32-bit computer architectures, 64-bit computer architectures, x86 computer architectures, advanced RISC machine (ARM) architectures, microprocessor without interlocked pipelined stages (MIPS) architectures, scalable processor architectures (SPARCs), load-store architectures, portions of one or more of the same, combinations or variations of one or more of the same, and/or any other suitable architectures or microarchitectures.

In some examples, the term “in-band” can refer to any feature, component, circuit, device, and/or process that is dedicated to and/or supports the user plane (e.g., user data and/or user applications) running on and/or implemented by a processor (e.g., a GPU). Examples of in-band agent 104 include, without limitation, in-band drivers, system consoles, kernel logs, user planes, data planes (e.g., a data plane of a data center), portions of one or more of the same, combinations or variations of one or more of the same, and/or any other suitable in-band agents.

In some examples, the term “out-of-band” can refer to any feature, component, circuit, device, and/or process that is dedicated to and/or supports the control plane (e.g., control data and/or firmware), the management plane, and/or data about the underlying device (e.g., a GPU). Additionally or alternatively, out-of-band agent 106 can include and/or represent a hardware-implemented device and/or circuit capable of controlling and/or modifying certain hardware features and/or components on an integrated circuit (e.g., a GPU). In one example, out-of-band agent 106 can include and/or represent a feature, device, and/or circuit that is onboard (e.g., on-chip) and/or internal to a GPU that implements machine check architecture 102 and/or processor 114. In another example, out-of-band agent 106 can include and/or represent a feature, device, and/or circuit implemented outside (e.g., off-chip) and/or external to the GPU that implements machine check architecture 102 and/or processor 114. Additional examples of out-of-band agent 106 include, without limitation, baseboard management controllers, system management units, system management controllers, control planes (e.g., a control plane of a data center), portions of one or more of the same, combinations or variations of one or more of the same, and/or any other suitable out-of-band agents.

In some examples, a GPU's in-band workload can include and/or represent computing tasks performed for and/or in connection with user applications running on a processor, and the GPU's out-of-band workload can include and/or represent computing tasks performed for any other purpose besides utilization and/or consumption by such user applications. In certain implementations, in-band agent 104 and out-of-band agent 106 are configured to make error-logging decisions independent of one another.

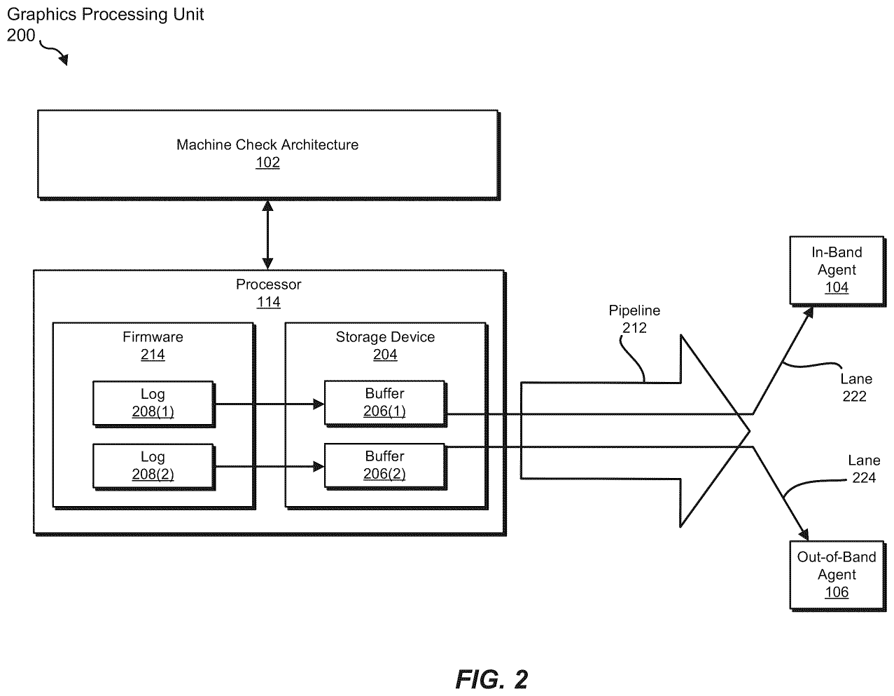

FIG. 2 illustrates an exemplary implementation of GPU 200 that facilitates and/or supports out-of-band delivery of error reports. In some examples, GPU 200 can include and/or represent certain devices, components, and/or features that perform and/or provide functionalities that are similar and/or identical to those described above in connection with FIG. 1. In one example, GPU 200 includes and/or represents machine check architecture 102, processor 114, a pipeline 212, in-band agent 104, and/or out-of-band agent 106. In this example, pipeline 212 electrically and/or communicatively couples processor 114 to in-band agent 104 and out-of-band agent 106.

In some examples, processor 114 implements and/or executes firmware 214 that performs various tasks and/or operations in connection with hardware error reporting. For example, firmware 214 obtains, retrieves, and/or receives a log of one or more hardware errors from machine check architecture 102. In one example, firmware 214 includes and/or represents specialized, low-level software embedded within memory of processor 114 and/or GPU 200. In this example, firmware 214 directly controls hardware on processor 114 and/or provides the necessary instructions to manage its operations.

In some examples, firmware 214 performs tasks like handling input/output, managing peripherals, processing data, and/or interfacing with other devices or features. In one example, unlike general-purpose software, firmware 214 is designed to be tightly coupled with the specific hardware of processor 114 and is often non-volatile such that it remains intact even when processor 114 and/or GPU 200 is powered off. In this example, firmware 214 constitutes and/or represents the functionality that enables processor 114 to interact with both hardware and higher-level software to achieve desired system behaviors.

In some examples, firmware 214 polls, samples, and/or queries machine check architecture 102 for recent hardware errors on a period basis (e.g., every 5 microseconds, every 2 millisecond, and/or every 100 milliseconds, etc.). For example, firmware 214 can poll and/or query machine check architecture 102 for hardware errors every millisecond. In one example, firmware 214 obtains a log 208(1) of recent hardware errors from machine check architecture 102 upon polling machine check architecture 102. In another example, machine check architecture 102 triggers, throws, and/or trips an interrupt when one or more hardware errors occur. In this example, firmware 214 obtains log 208(1) of such hardware errors from machine check architecture 102 in response to the interrupt.

In certain examples, firmware 214 clears, modifies, and/or marks a feature of machine check architecture 102 to indicate that log 208(1) and/or the corresponding errors have been reported (e.g., to processor 114, in-band agent 104, out-of-band agent 106, etc.). For example, firmware 214 can clear a register and/or bank of machine check architecture 102 by deleting data from the register and/or bank or replacing such data with zeros or ones. Examples of such a feature of machine check architecture 102 include, without limitation, blocks, subblocks, banks, registers, shadow registers, flags, status flags, combinations or variations of one or more of the same, and/or any other suitable feature.

In some examples, firmware 214 generates, creates, and/or produces a log 208(2) as a copy and/or duplicate of log 208(1). In one example, firmware 214 delivers, transmits, and/or sends log 208(1) or log 208(2) to each of in-band agent 104 and out-of-band agent 106. For example, processor 114 can include and/or represent a storage device 204, and processor 114 can allocate buffers 206(1)-(2) for storing logs 208(1)-(2), respectively. In this example, buffer 206(1) is configured and/or intended to deliver, transmit, and/or send log 208(1) to in-band agent 104 via pipeline 212. Additionally or alternatively, buffer 206(1) is configured and/or intended to deliver, transmit, and/or send log 208(2) to out-of-band agent 106 via pipeline 212.

In some examples, pipeline 212 includes and/or represents multiple lanes that communicatively and/or electrically couples buffers 206(1)-(2) to in-band agent 104 and out-of-band agent 106, respectively. For example, pipeline 212 can include and/or represent a lane 222 through which log 208(1) is carried from buffer 206(1) to in-band agent 104. In this example, pipeline 212 can also include and/or represent a lane 224 through which log 208(2) is carried from buffer 206(2) to out-of-band agent 106.

In some examples, storage device 204 includes and/or represents any type or form of volatile or non-volatile storage device or medium capable of storing and/or buffering logs of hardware errors. In one example, storage device 204 includes and/or represents a type or form of random access memory (RAM), such as static RAM (SRAM). Examples of storage device 204 include, without limitation, random access memory (RAM), read only memory (ROM), flash memory, hard disk drives (HDDs), solid-state drives (SSDs), optical disk drives, caches, variations or combinations of one or more of the same, and/or any other suitable memory.

In some examples, in-band agent 104 and/or out-of-band agent 106 can instruct and/or direct machine check architecture 102 to perform one or more specific actions in response to specific errors identified and/or included in log 208(1) and/or log 208(2). For example, out-of-band agent 106 can program and/or configure one or more registers and/or banks of machine check architecture 102 to initiate and/or trigger a specific action in response to a specific error. In one example, the specific action can include and/or represent triggering an interrupt that notifies out-of-band agent 106 of the specific error. For example, machine check architecture 102 can be programmed and/or configured to generate the interrupt that notifies out-of-band agent 106 of the specific error.

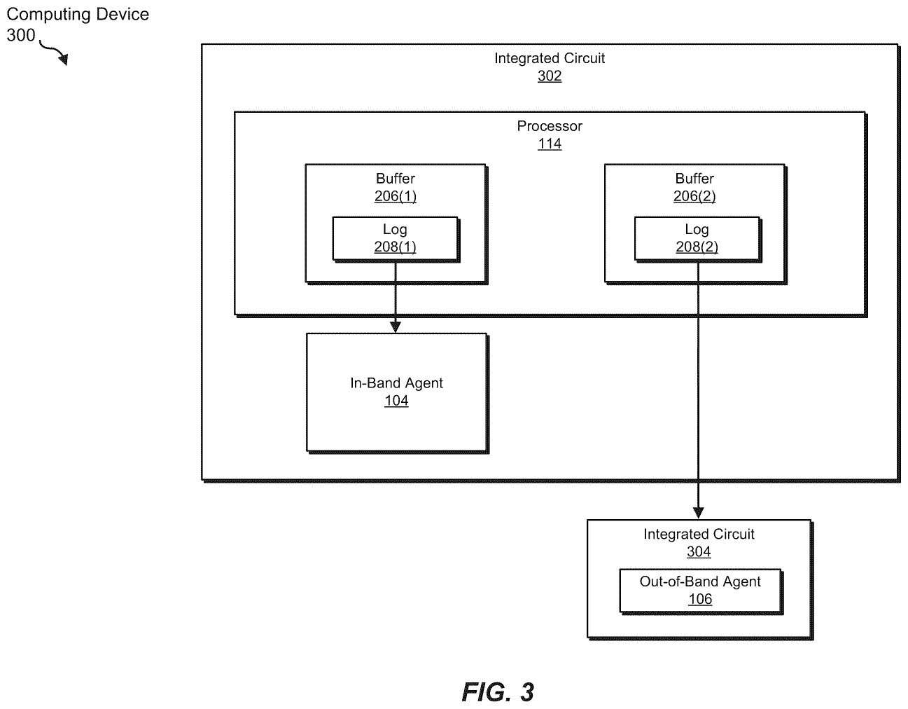

FIG. 3 illustrates an exemplary implementation of computing device 300 that facilitates and/or supports out-of-band delivery of error reports. In some examples, computing device 300 can include and/or represent certain components and/or features that perform and/or provide functionalities that are similar and/or identical to those described above in connection with either of FIGS. 1 and 2. In one example, computing device 300 includes and/or represents an integrated circuit 302 and/or an integrated circuit 304 communicatively coupled to one another. In this example, integrated circuit 302 includes and/or represents machine check architecture 102 and/or processor 114, and integrated circuit 304 includes and/or represents out-of-band agent 106. Accordingly, integrated circuit 304 is off-chip from and/or external to integrated circuit 302. However, integrated circuits 302 and 304 can be installed and/or applied to the same circuit board.

In some examples, integrated circuit 302 includes and/or represents a GPU with one or more GPU cores. In one example, processor 114 is on-chip and/or internal to the GPU, and out-of-band agent 106 is off-chip and/or external to the GPU. In this example, in-band agent is able to access log 208(1) stored in buffer 206(1) but is restricted from accessing log 208(2) stored in buffer 208(2). For example, in-band agent 104 can implement and/or execute an operating system that obtains, receives, and/or retrieves log 208(1) from buffer 206(1). Additionally or alternatively, out-of-band agent 106 is able to access log 208(2) stored in buffer 206(2) but is restricted from accessing the log 208(1) stored in buffer 206(1).

In some examples, in-band agent 104 and out-of-band agent 106 can make error-logging decisions independent of one another. For example, in-band agent 104 can clear a certain flag (e.g., a status flag) in in-band registers that remains set in out-of-band registers. Alternatively, out-of-band agent 106 can clear a certain flag (e.g., a status flag) in out-of-band registers that remains set in in-band registers. Either way, such flag mismatches across in-band registers and out-of-band registers can cause in-band registers and out-of-band registers to log and/or disregard different errors from the same error reports. Accordingly, in-band agent 104 and out-of-band agent 106 can have independent control and/or programmability over their respective registers in machine check architecture 102.

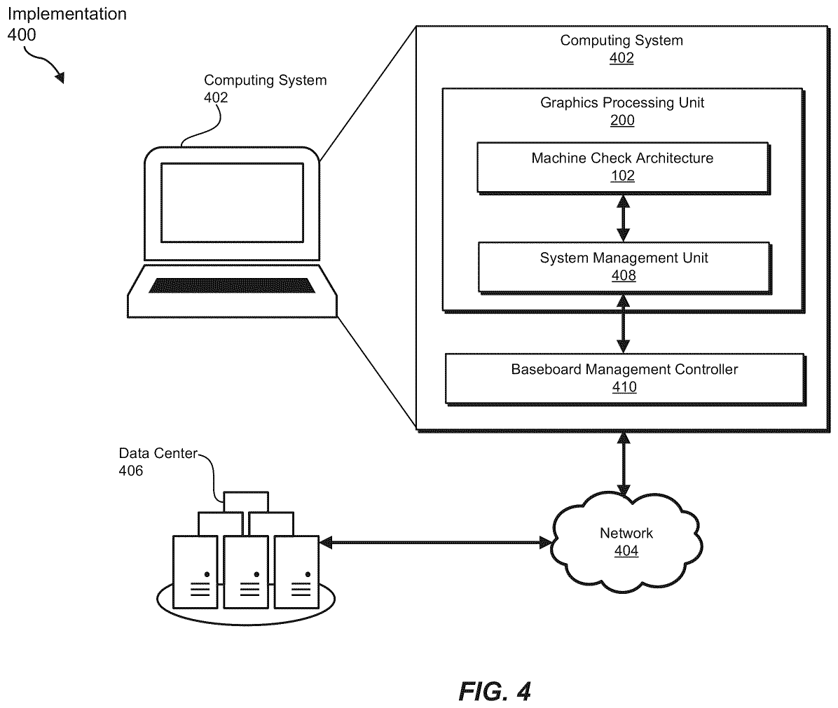

FIG. 4 illustrates another exemplary implementation in which a computing system 402 reports errors to the control plane of a data center 406. In some examples, computing system 402 can include and/or represent certain components and/or features that perform and/or provide functionalities that are similar and/or identical to those described above in connection with any of FIGS. 1-3. As illustrated in exemplary implementation 400 in FIG. 4, computing system 402 includes and/or represents GPU 200 equipped with machine check architecture 102 and/or a system management unit 408.

In some examples, computing system 402 also includes and/or represents a baseboard management controller 410 that is electrically and/or communicatively coupled to system management unit 408. In one example, system management unit 408 obtains, receives, and/or retrieves an error report from an out-of-band register in machine check architecture 102. In this example, system management unit 408 uses the error report to duplicate and/or reproduce a copy of the error report.

In some examples, system management unit 408 delivers, provides, and/or transmits one copy of the error report to an in-band driver, which then forwards the error report to a system console or kernel log for processing and/or to facilitate decision-making. In such examples, system management unit 408 delivers, provides, and/or transmits another copy of the error report to baseboard management controller 410, which then forwards the error report to the control plane of data center 406 via a network 404 for processing and/or to facilitate decision-making.

In some examples, the various devices and/or systems described in connection with FIGS. 1-5 can include and/or represent one or more additional circuits, components, and/or features that are not necessarily illustrated and/or labeled in FIGS. 1-5. For example, computing device 100 can also include and/or represent additional analog and/or digital circuitry, onboard logic, transistors, resistors, capacitors, diodes, inductors, switches, registers, flipflops, connections, traces, buses, semiconductor (e.g., silicon) devices and/or structures, processing devices, storage devices, circuit boards, packages, substrates, housings, combinations or variations of one or more of the same, and/or any other suitable components that facilitate and/or support out-of-band delivery of error reports. In certain implementations, one or more of these additional circuits, components, devices, and/or features can be inserted and/or applied between any of the existing circuits, components, and/or devices illustrated in FIGS. 1-5 consistent with the aims and/or objectives provided herein. Accordingly, the electrical and/or communicative couplings described with reference to FIGS. 1-5 can be direct connections with no intermediate components, devices, and/or nodes or indirect connections with one or more intermediate components, devices, and/or nodes.

In some examples, the phrase “to couple” and/or the term “coupling,” as used herein, can refer to a direct connection and/or an indirect connection. For example, a direct coupling between two components can constitute and/or represent a coupling in which those two components are directly connected to each other by a single node that provides electrical continuity from one of those two components to the other. In other words, the direct coupling can exclude and/or omit any additional components between those two components.

Additionally or alternatively, an indirect coupling between two components can constitute and/or represent a coupling in which those two components are indirectly connected to each other by multiple nodes that fail to provide electrical continuity from one of those two components to the other. In other words, the indirect coupling can include and/or incorporate at least one additional component between those two components.

FIG. 6 is a flow diagram of an exemplary method 600 for out-of-band delivery of error reports. In one example, the steps shown in FIG. 6 can be performed and/or executed during the manufacturing and/or assembly of a computing device and/or system. Additionally or alternatively, the steps shown in FIG. 6 can also incorporate and/or involve various sub-steps and/or variations consistent with the descriptions provided above in connection with FIGS. 1-5.

As illustrated in FIG. 6, exemplary method 600 include and/or involve the step of creating a machine check architecture that logs hardware errors (610). Step 610 can be performed in a variety of ways, including any of those described above in connection with FIGS. 1-5. For example, a computing equipment manufacturer and/or subcontractor can create, manufacture, and/or produce a machine check architecture that logs hardware errors.

Exemplary method 600 also includes the step of configuring a processor to obtain a log of one or more of the hardware errors from the machine check architecture (620). Step 620 can be performed in a variety of ways, including any of those described above in connection with FIGS. 1-5. For example, the computing equipment manufacturer and/or subcontractor can configure a processor to obtain a log of one or more of the hardware errors from the machine check architecture.

Exemplary method 600 further includes the step of configuring the processor to generate a copy of the log (630). Step 630 can be performed in a variety of ways, including any of those described above in connection with FIGS. 1-5. For example, the computing equipment manufacturer and/or subcontractor can configure the processor to generate a copy of the log.

Exemplary method 600 additionally includes the step of configuring the processor to either (1) deliver the log to an in-band agent and the copy of the log to an out-of-band agent or (2) deliver the copy of the log to the in-band agent and the log to the out-of-band agent (640). Step 640 can be performed in a variety of ways, including any of those described above in connection with FIGS. 1-5. For example, the computing equipment manufacturer and/or subcontractor can configure the processor to either (1) deliver the log to an in-band agent and the copy of the log to an out-of-band agent or (2) deliver the copy of the log to the in-band agent and the log to the out-of-band agent.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality. Furthermore, the various steps, events, and/or features performed by such components should be considered exemplary in nature since many alternatives and/or variations can be implemented to achieve the same functionality within the scope of this disclosure.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the instant disclosure. The implementations disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a machine check architecture configured to log hardware errors; and
a processor configured to:
obtain a log of one or more of the hardware errors from the machine check architecture;
generate a copy of the log; and
either:
deliver the log to an in-band agent and the copy of the log to an out-of-band agent; or
deliver the copy of the log to the in-band agent and the log to the out-of-band agent.

2. The system of claim 1, wherein the processor is configured to execute firmware that obtains the log and generates the copy of the log.

3. The system of claim 2, wherein the firmware is configured to:
allocate a first buffer for storing the log or the copy of the log destined for the in-band agent; and
allocate a second buffer for storing the log or the copy of the log destined for the out-of-band agent.

4. The system of claim 3, wherein the processor is configured to:
deliver the log or the copy of the log to the in-band agent via the first buffer; and
deliver the log or the copy of the log to the out-of-band agent via the second buffer.

5. The system of claim 2, wherein the firmware is configured to:
poll the machine check architecture on a periodic basis; and
obtain the log upon polling the machine check architecture.

6. The system of claim 2, wherein the firmware is configured to clear, after obtaining the log, a feature of the machine check architecture to indicate that the log has been reported.

7. The system of claim 2, wherein:
the machine check architecture is configured to trigger an interrupt when a hardware error occurs; and
the firmware is configured to obtain the log in response to the interrupt having been triggered.

8. The system of claim 1, wherein the in-band agent comprises at least one of:
a driver;
a system console;
a kernel log; or
a data plane of a data center.

9. The system of claim 1, wherein the out-of-band agent comprises at least one of:
a baseboard management controller;
a system management unit; or
a control plane of a data center.

10. The system of claim 1, further comprising a pipeline that includes:
a first lane that carries the log or the copy of the log toward the in-band agent; and
a second lane that carries the log or the copy of the log toward the out-of-band agent.

11. The system of claim 1, further comprising a graphics processing unit that implements machine check architecture and the processor.

12. The system of claim 1, wherein the in-band agent and the out-of-band agent are configured to make error-logging decisions independent of one another.

13. The system of claim 1, wherein the out-of-band agent is configured to instruct the machine check architecture to perform a specific action in response to a specific error identified in the log.

14. A graphics processing unit comprising:
a machine check architecture configured to log hardware errors; and
a microcontroller configured to:
obtain a log of one or more of the hardware errors from the machine check architecture;
generate a copy of the log; and
either:
deliver the log to an in-band agent and the copy of the log to an out-of-band agent; or
deliver the copy of the log to the in-band agent and the log to the out-of-band agent.

15. The graphics processing unit of claim 14, wherein the microcontroller is further configured to execute firmware that obtains the log and generates the copy of the log.

16. The graphics processing unit of claim 15, wherein the firmware is configured to:
allocate a first buffer for storing the log or the copy of the log destined for the in-band agent; and
allocate a second buffer for storing the log or the copy of the log destined for the out-of-band agent.

17. The graphics processing unit of claim 16, wherein the microcontroller is configured to:
deliver the log or the copy of the log to the in-band agent via the first buffer; and
deliver the log or the copy of the log to the out-of-band agent via the second buffer.

18. The graphics processing unit of claim 15, wherein the firmware is configured to:
poll the machine check architecture on a periodic basis; and
obtain the log upon polling the machine check architecture.

19. The graphics processing unit of claim 15, wherein the firmware is configured to clear, after obtaining the log, a feature of the machine check architecture to indicate that the log has been reported.

20. A method comprising:
creating a machine check architecture that logs hardware errors; and
configuring a processor to:
obtain a log of one or more of the hardware errors from the machine check architecture;
generate a copy of the log; and
either:
deliver the log to an in-band agent and the copy of the log to an out-of-band agent; or
deliver the copy of the log to the in-band agent and the log to the out-of-band agent.
